(19) United States
(12) Patent Application Publication
(10) Pub. No.: US 2024/0275511 A1
(43) Pub. Date: Aug. 15, 2024

(54) CONTROL SYSTEM AND CONTROL DEVICE

(71) Applicant: KABUSHIKI KAISHA TOSHIBA, Tokyo (JP)

(72) Inventors: Takahiro YAMAURA, Kawasaki (JP); Yasin OGE, Sagamihara (JP); Yuta KOBAYASHI, Ota (JP)

(73) Assignee: KABUSHIKI KAISHA TOSHIBA, Tokyo (JP)

(21) Appl. No.: 18/490,836

(22) Filed: Oct. 20, 2023

(30) Foreign Application Priority Data
Feb. 14, 2023 (JP) 2023-020804

(51) Int. Cl. H04J 3/06

(52) U.S. Cl. CPC H04J 3/0641; H04J 3/0658

(57) ABSTRACT

According to one embodiment, a control system includes first and second control devices. The first control device includes a management unit that manages global time, a first generation unit that generates local time, a control unit that controls an operation of the first control device based on the global time, the local time, and operation control information, and a second generation unit that generates time error information based on the global time and the local time. The second control device includes an acquisition unit that acquires the time error information, and a correction unit that corrects the operation control information based on the time error information.

### CROSS-REFERENCE TO RELATED APPLICATIONS

This application is based upon and claims the benefit of priority from Japanese Patent Application No. 2023-020804, filed Feb. 14, 2023, the entire contents of which are incorporated herein by reference.

### FIELD

Embodiments described herein relate generally to a control system and a control device.

### BACKGROUND

In general, in a control system including a plurality of control devices (a communication transfer device, an information processing device, and the like) communicably connected via a network, it is known that each control device operates based on time synchronized in the entire network (hereinafter, denoted as global time).

With such a control system, it is possible to uniformly manage time in the control system and to efficiently switch processing in the entire control system.

By the way, since the switching of processing by the global time has a large overhead, in order to alleviate the influence of the overhead, it is conceivable to configure the control device to operate with reference to the global time as necessary while basically operating with reference to the time (hereinafter, referred to as local time) generated in each control device.

However, for example, in a case where there is a deviation (error) in the way the global time and the local time advance, the control device may not be able to operate properly.

### BRIEF DESCRIPTION OF THE DRAWINGS

FIG. 1 is a diagram illustrating an example of a network configuration of a control system according to an embodiment.

FIG. 2 is a diagram illustrating an example of a functional configuration of a grand master device according to a comparative example of the present embodiment.

FIG. 3 is a diagram illustrating an example of a functional configuration of a communication transfer device in the comparative example of the present embodiment.

FIG. 4 is a diagram illustrating an example of a functional configuration of an information processing device according to the comparative example of the present embodiment.

FIG. 5 is a diagram illustrating an example of a functional configuration of an orchestration device in the comparative example of the present embodiment.

FIG. 6 is a diagram illustrating an example of gate control information.

FIG. 7 is a diagram illustrating an example of scheduling information.

FIG. 8 is a diagram illustrating an example of a functional configuration of the communication transfer device according to the present embodiment.

FIG. 9 is a diagram illustrating an example of a functional configuration of the information processing device according to the present embodiment.

FIG. 10 is a diagram illustrating an example of a functional configuration of the orchestration device according to the present embodiment.

FIG. 11 is a flowchart illustrating an example of a processing procedure of time error information notification processing.

FIG. 12 is a diagram illustrating an operation of a difference calculation unit.

FIG. 13 is a diagram conceptually illustrating global time increase value and local time increase value measured according to a periodic operation.

FIG. 14 is a flowchart illustrating an example of a processing procedure of operation control information correction processing.

FIG. 15 is a diagram illustrating an example of gate control information corrected by executing first processing.

FIG. 16 is a diagram illustrating an example of scheduling information corrected by executing the first processing.

FIG. 17 is a diagram illustrating an example of gate control information corrected by executing second processing.

FIG. 18 is a diagram illustrating an example of scheduling information corrected by executing the second processing.

FIG. 19 is a diagram illustrating another example of gate control information corrected by executing the second processing.

FIG. 20 is a diagram illustrating an example of a screen on which identification information output from the orchestration device is displayed.

FIG. 21 is a diagram illustrating an example of a screen generated based on the identification information output from the orchestration device.

### DETAILED DESCRIPTION

In general, according to one embodiment, a control system includes first and second control devices communicably connected via a network. The first control device includes a management unit that manages global time, a first generation unit that generates local time, a control unit that controls an operation of the first control device based on the global time, the local time, and operation control information defining the operation of the first control device, and a second generation unit that generates time error information indicating a time error based on the global time and the local time. The second control device includes an acquisition unit that acquires the generated time error information from the first control device, and a correction unit that corrects the operation control information based on the acquired time error information.

Various embodiments will be described with reference to the accompanying drawings.

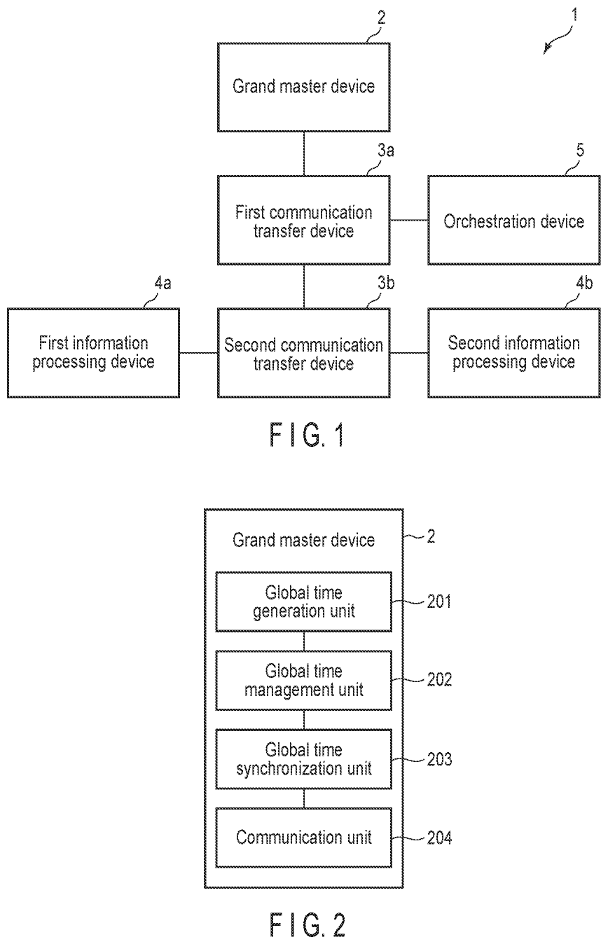

FIG. 1 illustrates an example of a network configuration of a control system according to the present embodiment. In the example illustrated in FIG. 1, a control system 1 includes a grand master device 2, a first communication transfer device 3a, a second communication transfer device 3b, a first information processing device 4a, and a second information processing device 4b.

Note that the grand master device 2 is connected to the first communication transfer device 3a via a network. The first communication transfer device 3a is connected to the second communication transfer device 3b via a network. The second communication transfer device 3b is connected to the first information processing device 4a and the second information processing device 4b via a network.

In the present embodiment, the grand master device 2, the first communication transfer device 3a, the second communication transfer device 3b, the first information processing device 4a, and the second information processing device 4b are time-synchronized, for example, by precision time protocol (PTP) defined by IEEE 1588 or generalized precision time protocol (gPTP) defined by IEEE 802.1AS. Time synchronization using PTP or gPTP is realized by a master device (master equipment) that is a source of provision of reference time and a slave device (slave equipment) that is synchronized with the reference time by communicating with the master device.

The grand master device 2 is the highest-order device of the master device that is the source of provision of the reference time in the time synchronization. In this case, the grand master device 2 operates as a master device, the first communication transfer device 3a (the communication port of the first communication transfer device 3a to which the grand master device 2 is connected) operates as a slave device, and the time managed by the first communication transfer device 3a is synchronized with the reference time provided by the grand master device 2.

In addition, the first communication transfer device 3a (the communication port of the first communication transfer device 3a connected to the second communication transfer device 3b) operates as a master device, the second communication transfer device 3b (the communication port of the second communication transfer device 3b connected to the first communication transfer device 3a) operates as a slave device, and the time managed by the second communication transfer device 3b is synchronized with the time managed by the first communication transfer device 3a (the time synchronized with the reference time).

Furthermore, the second communication transfer device 3b (the communication port of the second communication transfer device 3b connected to the first information processing device 4a) operates as a master device, the first information processing device 4a operates as a slave device, and the time managed by the first information processing device 4a is synchronized with the time managed by the second communication transfer device 3b (the time synchronized with the reference time).

Also, the second communication transfer device 3b (the communication port of the second communication transfer device 3b connected to the second information processing device 4b) operates as a master device, the second information processing device 4b operates as a slave device, and the time managed by second information processing device 4b is synchronized with the time managed by the second communication transfer device 3b (the time synchronized with the reference time).

In the present embodiment, as described above, by synchronizing the time managed by the first communication transfer device 3a, the second communication transfer device 3b, the first information processing device 4a, and the second information processing device 4b with the reference time provided by the grand master device 2, an efficient operation in the control system 1 can be realized with reference to the time. Note that, in the present embodiment, it is described that the communication transfer device operates as the slave device with respect to the upper master device to synchronize its own clock and operates by the boundary clock operating as the master device with respect to the slave device connected at the lower level. However, the communication transfer device may operate by the transparent clock operating by measuring the time taken to transfer a frame passing through the communication transfer device, recording the time in the frame, and transferring the frame.

In the following description, a reference time synchronized in the entire system by a time synchronization protocol such as PTP or gPTP described above is referred to as global time.

Here, the control system 1 according to the present embodiment further includes an orchestration device 5. The orchestration device 5 generates, for example, operation control information in which the operations of the first communication transfer device 3a and the second communication transfer device 3b are defined. Furthermore, the orchestration device 5 generates, for example, operation control information in which the operations of the first information processing device 4a and the second information processing device 4b are defined.

In this case, the first communication transfer device 3a, the second communication transfer device 3b, the first information processing device 4a, and the second information processing device 4b each operate according to the operation control information generated by the orchestration device 5.

In the present embodiment, the first communication transfer device 3a and the second communication transfer device 3b execute, for example, processing of transmitting and receiving (transferring) various items of data (frames) in the control system 1. In addition, the first information processing device 4a and the second information processing device 4b execute information processing including various calculations, input/output control for peripheral equipment (peripherals), and the like, for example, by executing a program arranged on a memory by a central processing unit such as a CPU.

Note that the communication transfer device (the first communication transfer device 3a and the second communication transfer device 3b), the information processing devices (the first information processing device 4a and the second information processing device 4b), and the orchestration device 5 described above correspond to control devices included in the control system 1 according to the present embodiment.

Hereinafter, before describing the control system 1 according to the present embodiment in detail, a comparative example of the present embodiment is described. Note that the control system according to the comparative example of the present embodiment has the configuration described in FIG. 1. Therefore, FIG. 1 is also referred to in the following description of a control system according to a comparative example of the present embodiment.

Here, the control system 1 according to the comparative example of the present embodiment can efficiently switch processing in the entire control system 1 by each device included in the control system 1 operating with reference to the global time. However, switching of processing by the global time has a large overhead.

Specifically, the communication transfer device including the first communication transfer device 3a and the second communication transfer device 3b is assumed to be realized, for example, as a network switch, and is basically configured to operate based on a local clock signal generated from an oscillator (oscillation circuit) mounted on the communication transfer device. Therefore, as long as a circuit operates based on the local time, the circuit can fixedly handle the elapse of time from the number of times of entry of the local signal, but in a case where the communication transfer device refers to the global time, switching of the operation according to the global time causes clock transfer (processing for enabling reference to data in different clock domains) and complication of determination conditions, and increases the circuit scale and processing overhead.

Furthermore, the information processing device including the first information processing device 4a and the second information processing device 4b is assumed to be realized, for example, as an electronic equipment (for example, a personal computer) or the like into which a network card compatible with the Time-Sensitive Networking (TSN) standard defined in IEEE 802.1 is inserted. In this case, since the global time is managed on the network card side, the overhead for reading the global time increases.

Therefore, the communication transfer device and the information processing device included in the control system 1 according to the modification of the present embodiment are configured to operate with reference to the local time in addition to the global time.

FIG. 2 illustrates an example of a functional configuration of the grand master device 2 according to the comparative example of the present embodiment. As illustrated in FIG. 2, the grand master device 2 includes a global time generation unit 201, a global time management unit 202, a global time synchronization unit 203, and a communication unit 204.

The global time generation unit 201 generates a global time provided by the grand master device 2. The global time generation unit 201 generates the global time, for example, based on local time of the grand master device 2 based on a signal received from a global navigation satellite system (GNSS).

The global time generated by the global time generation unit 201 is represented by 48 bits of a second counter and 32 bits of a nanosecond counter, for example, using the standard atomic time TAI and is managed (stored) by the global time management unit 202.

The global time synchronization unit 203 executes high-precision time synchronization using PTP or gPTP. The global time synchronization unit 203 acquires the global time managed by the global time management unit 202 and transmits the acquired global time to the first communication transfer device 3a via the communication unit 204.

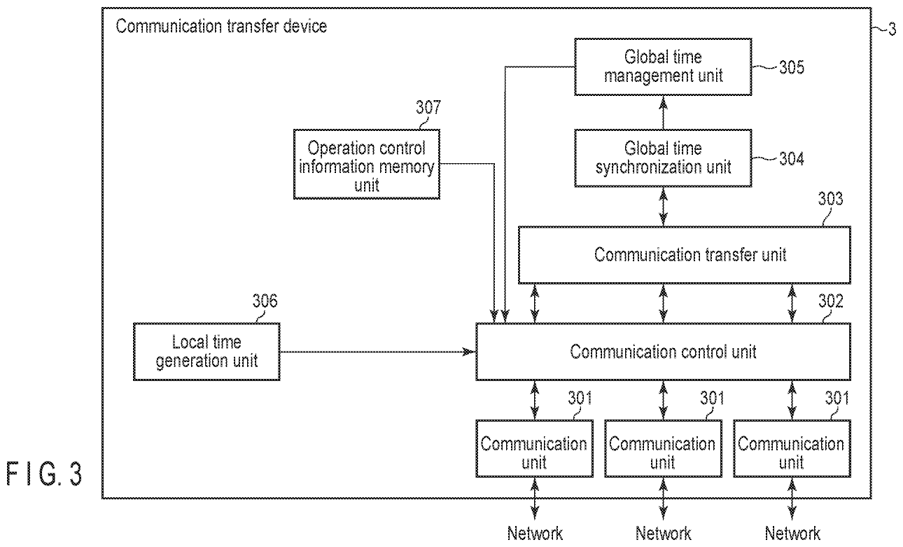

FIG. 3 illustrates an example of a functional configuration of the communication transfer device (the first communication transfer device 3a and the second communication transfer device 3b) in the comparative example of the present embodiment. As illustrated in FIG. 3, a communication transfer device 3 includes a communication unit 301, a communication control unit 302, a communication transfer unit 303, a global time synchronization unit 304, a global time management unit 305, a local time generation unit 306, and an operation control information memory unit 307.

The communication unit 301 transmits and receives frames via a network. The communication unit 301 executes processing for performing communication, for example, by using a protocol such as Ethernet (registered trademark). Specifically, the communication unit 301 executes processing of a data link layer and a physical layer in an OSI reference model and realizes functions referred to as a media access controller (MAC) and PHY.

Note that the frames transmitted and received by the communication unit 301 include data such as the global time provided by the grand master device 2, results of the processing executed in the first information processing device 4a and the second information processing device 4b, and the operation control information generated by the orchestration device 5.

Furthermore, the communication unit 301 is provided for each communication port of the communication transfer device 3. Specifically, for example, when the communication transfer device 3 is the first communication transfer device 3a, the first communication transfer device 3a includes the communication unit 301 corresponding to a communication port connected to the grand master device 2, the communication unit 301 corresponding to a communication port connected to the second communication transfer device 3b, and the communication unit 301 corresponding to a communication port connected to the orchestration device 5. Furthermore, for example, in a case where the communication transfer device 3 is the second communication transfer device 3b, the second communication transfer device 3b includes the communication unit 301 corresponding to a communication port connected to the first communication transfer device 3a, the communication unit 301 corresponding to a communication port connected to the first information processing device 4a, and the communication unit 301 corresponding to a communication port connected to the second information processing device 4b.

The communication control unit 302 controls the operation of the communication transfer device 3 based on the global time, the local time, and the operation control information. Specifically, the communication control unit 302 executes transmission processing and reception processing according to the TSN standard described above.

The communication transfer unit 303 transfers information (data of the time synchronization frame) necessary for synchronization of the global time, for example, between the communication control unit 302 and the global time synchronization unit 304.

The global time synchronization unit 304 executes high-precision time synchronization using PTP or gPTP.

Here, regarding time synchronization, the communication transfer devices 3 (the first communication transfer device 3a and the second communication transfer device 3b) operate as a master device and a slave device by devices to be communication counterparts, and the global time synchronization unit 304 executes different processing depending on whether the communication transfer device 3 operates as the master device or operates the slave device for each communication port.

In the processing of the communication transfer device 3 as the master device, the global time synchronization unit 304 transmits (the information of) the global time acquired (read) from the global time management unit 305 to the slave device via the communication transfer unit 303, the communication control unit 302, and the communication unit 301. Note that the global time information is, for example, time stamp information indicating the time.

In a case where the communication transfer device 3 operates as a slave device, the global time synchronization unit 304 obtains time until a frame is transmitted from the master device (that is, unidirectional delay time corresponding to ½ of the round-trip delay time) from round-trip delay time of a network between the communication transfer device 3 and the master device (time required for the frame to reciprocate between the master device and the slave device). The global time synchronization unit 304 adds the unidirectional delay time to the global time (time stamp) transmitted from the master device and executes correction processing for the global time managed by the global time management unit 305. It is assumed that the round-trip delay time of the network is, for example, measured in advance and stored inside the communication transfer device 3 (global time synchronization unit 304).

Note that the correction processing is executed so that the operation of the communication transfer device 3 executed with reference to the global time is appropriately maintained. Specifically, for example, in a case where the global time transmitted from the master device is ahead of the global time managed by the global time management unit 305, correction processing is executed such that the global time managed by the global time management unit 305 does not rapidly advance (that is, the synchronization is performed by gradually proceeding). Meanwhile, for example, in a case where the global time transmitted from the master device is delayed from the global time managed by the global time management unit 305, correction processing is executed such that the global time managed by the global time management unit 305 does not rewound (that is, the synchronization is executed by delaying the progress of the global time).

The global time management unit 305 manages the global time described above. The local time generation unit 306 generates local time based on a clock provided inside the communication transfer device 3. Specifically, the local time is, for example, time generated from a clock signal generated by using an oscillator (oscillation circuit). The local time may be realized by a counter that counts up with a clock signal. The local time generation unit 306 may generate, for example, the local time for each clock having different frequencies.

The global time managed by the global time management unit 305 and the local time generated by the local time generation unit 306 are referred to when the communication control unit 302 controls the operation of the communication transfer device 3.

The operation control information memory unit 307 is configured to store the operation control information generated by the orchestration device 5. The operation control information stored in the operation control information memory unit 307 is used by the communication control unit 302 to control the operation of the communication transfer device 3.

Note that some or all of the units 301 to 307 illustrated in FIG. 3 may be realized by a computer of the communication transfer device 3 executing a predetermined program (that is, software), may be realized by hardware, or may be realized by a combination of software and hardware.

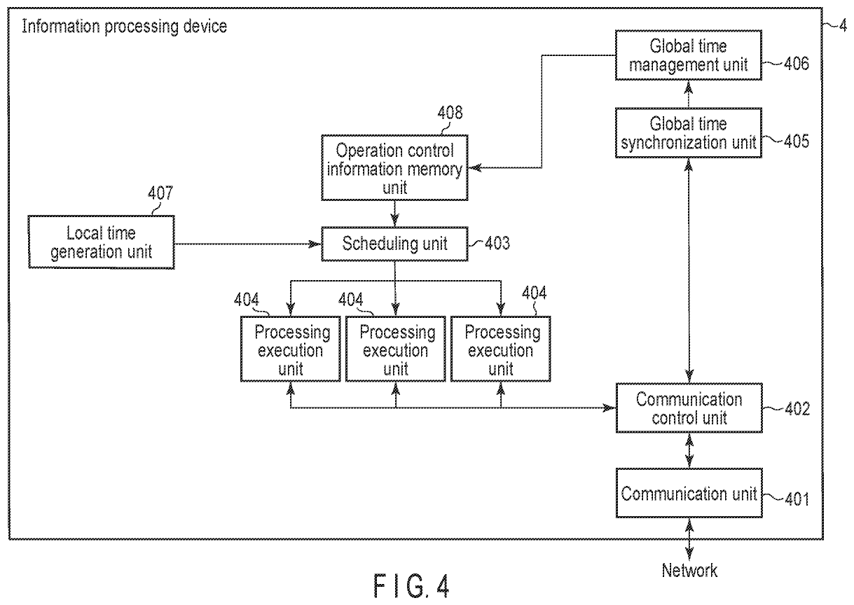

FIG. 4 illustrates an example of functional configurations of the information processing devices (the first information processing device 4a and the second information processing device 4b) in the comparative example of the present embodiment. As illustrated in FIG. 4, an information processing device 4 includes a communication unit 401, a communication control unit 402, a scheduling unit 403, a processing execution unit 404, a global time synchronization unit 405, a global time management unit 406, a local time generation unit 407, and an operation control information memory unit 408.

The communication unit 401 receives, for example, a frame (data) transmitted from the communication transfer device 3. The frame received by the communication unit 401 includes data such as global time managed in the communication transfer device 3, a result of processing executed in another information processing device 4, and operation control information generated by the orchestration device 5. The communication control unit 402 controls communication with the communication transfer device 3 via the communication unit 401 described above.

The scheduling unit 403 controls the operation of the information processing device 4 based on the global time, the local time, and the operation control information. Specifically, the scheduling unit 403 schedules the processing executed by the processing execution unit 404.

The processing execution unit 404 is provided, for example, so as to correspond to each of cores included in a CPU (a processor, a host processor) included in the information processing device 4. The processing execution unit 404 executes processing, for example, in units of virtual machines.

Note that a result of the processing executed by the processing execution unit 404 is transmitted to the communication transfer device 3 (another information processing device 4) via the communication control unit 402 and the communication unit 401.

Since the global time synchronization unit 405, the global time management unit 406, the local time generation unit 407, and the operation control information memory unit 408 are similar to the global time synchronization unit 304, the global time management unit 305, the local time generation unit 306, and the operation control information memory unit 307 included in the communication transfer device 3 described above, detailed descriptions thereof are omitted here. However, it is assumed that the information processing device 4 operates only as the slave device with the communication transfer device 3 as the master device.

Note that some or all of the units 401 to 408 illustrated in FIG. 4 may be realized by a computer of the information processing device 4 executing a predetermined program (that is, software), may be realized by hardware, or may be realized by a combination of software and hardware.

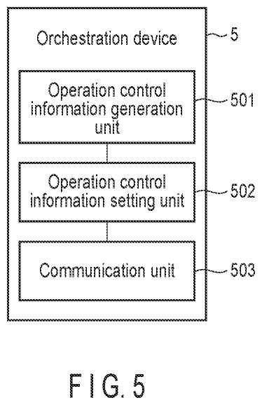

FIG. 5 illustrates an example of a functional configuration of the orchestration device 5 in the comparative example of the present embodiment. As illustrated in FIG. 5, the orchestration device 5 includes an operation control information generation unit 501, an operation control information setting unit 502, and a communication unit 503.

The operation control information generation unit 501 generates operation control information defining the operations of the communication transfer device 3 and the information processing device 4. Note that the operation control information is generated in a case where the operation control information is not set for the communication transfer device 3 and the information processing device 4 (that is, the device whose operation is controlled based on the operation control information). Furthermore, the operation control information may be generated, for example, in a case where it is necessary to reset the operation control information due to addition of a new application in the information processing device 4.

The operation control information setting unit 502 sets, for example, operation control information, which is generated by the operation control information generation unit 501 and in which the operation of the communication transfer device 3 is defined, for (the communication control unit 302 included in) the communication transfer device 3. Furthermore, the operation control information setting unit 502 sets, for example, operation control information, which is generated by the operation control information generation unit 501 and in which the operation of the information processing device 4 is defined, for (the scheduling unit 403 included in) the information processing device 4.

The communication unit 503 transmits the operation control information set for the communication transfer device 3 by the operation control information setting unit 502 to the communication transfer device 3. Also, the communication unit 503 transmits the operation control information set for the information processing device 4 by the operation control information setting unit 502 to the information processing device 4.

Note that some or all of the units 501 to 503 illustrated in FIG. 5 may be realized by a computer of the orchestration device 5 executing a predetermined program (that is, software), may be realized by hardware, or may be realized by a combination of software and hardware.

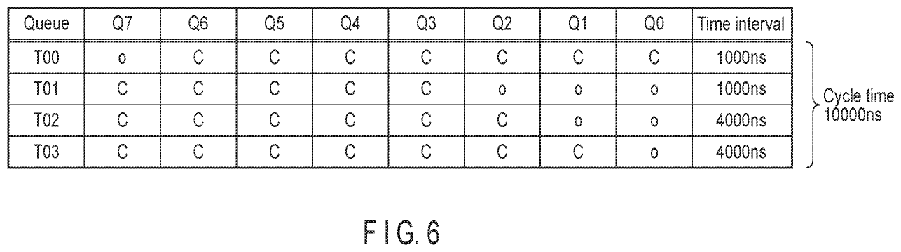

Next, the above-described operation control information is described. First, operation control information that defines the operation of the communication transfer device 3 is described with reference to FIG. 6.

Here, for example, in Enhancements for Scheduled Traffic (EST) or Per-Stream Filtering and Policing (PSFP) defined in IEEE 802.1Q, transmission and reception of frames can be controlled by opening and closing a gate for each communication unit 301. The gate opening/closing operation (gate control) is executed based on gate control information (gate control list).

FIG. 6 illustrates an example of gate control information. In the gate control information, opening and closing of the gate corresponding to each of a plurality of queues in which the frame to be transmitted and received is stored is set.

The gate control information illustrated in FIG. 6 includes four entries from “T00” to “T03”. Each entry includes an open or closed state of the gate corresponding to each of the eight queues from “Q0” to “Q7” (hereinafter, referred to as a queue gate state) and a time interval. Note that the queues “Q0” to “Q7” correspond to the eight traffic classes, respectively. Note that, in FIG. 6, for example, the queue “Q7” is a queue corresponding to a traffic class with the highest priority, and the queue “Q0” is a queue corresponding to a traffic class with the lowest priority.

The gate state of each queue is represented by “O” and “C”. “O” means that the gate is open. “C” means that the gate is closed. When the gate is open, transmission in the queue (transmission of the frame stored in the queue) is permitted. On the other hand, when the gate is closed, transmission in the queue is not permitted. That is, according to such gate control information, it is possible to execute control such that the frame is allowed to pass in a case where the gate of the queue is open, and the frame is not allowed to pass in a case where the gate of the queue is closed.

The time interval represents time during which the gate control corresponding to the entry continues. For example, in the example of FIG. 6, 1000 ns is set as the time interval included in the entry “T00”. In this case, the gate control corresponding to the entry “T00” (gate states corresponding to the queues “Q0” to “Q7”) is continued for 1000 ns.

Here, according to the gate control information illustrated in FIG. 6, the entry is switched to the next entry according to the time interval included in each entry. For example, when the time interval included in the entry “T00” elapses, the entry “T00” is switched to the entry “T01”. When the entry is switched in this manner, the gate states of the queues “Q0” to “Q7” are similarly switched.

Specifically, during the time interval included in the entry “T00”, the queues “Q0” to “Q” are closed, and the queue “Q7” is opened. When the entry “T00” is switched to the entry “T01”, the queues “Q” to “Q7” are closed, and the queues “Q0” to “Q” are opened, during the time interval included in the entry “T01”. The same applies to the entry “T02” and the subsequent entries.

When the cycle time of 10000 ns has elapsed, the gate control for one cycle is completed, the process returns to the first entry (entry “T00” in the example of FIG. 6), and the gate control is repeated.

The gate control information is an example of the operation control information in which the operation of the communication transfer device 3 is defined.

Here, in order to improve the efficiency of the processing of the entire control system 1, the communication transfer device 3 desirably operates with reference to the global time synchronized in the entire control system 1. Therefore, for example, it is assumed that the start timing of the gate control corresponding to the entry “T00” is designated by the global time. The start time of the gate control corresponding to the entry “T00” is controlled by a start reference time referred to as base time and a periodic operation time referred to as cycle time in which the gate control for one cycle is repeated. Specifically, the gate control corresponding to the entry “T00” is started when the global time coincides with “base time+(n×cycle time)”. n is an integer of 1 or more.

Meanwhile, since the switching of the processing with reference to the global time has a large overhead as described above, for example, processing other than the start of the gate control corresponding to the entry “T00” (that is, the gate control and the like corresponding to the entry “T01”) is executed with reference to the local time (for example, the Ethernet transmission clock). The transmission clock of the Ethernet varies depending on the link speed, and for example, the transmission clock in a case where the link speed is 1 Gbps is 125 MHZ, and the transmission clock in a case where the link speed is 10 Gbps is 156.25 MHz. Note that the global time may be, for example, based on a different clock (frequency) such as 200 MHZ.

As described above, the communication control unit 302 included in the communication transfer device 3 according to the comparative example of the present embodiment can control the operation (frame transmission processing or reception processing) of the communication transfer device 3 based on the global time, the local time, and the gate control information (operation control information).

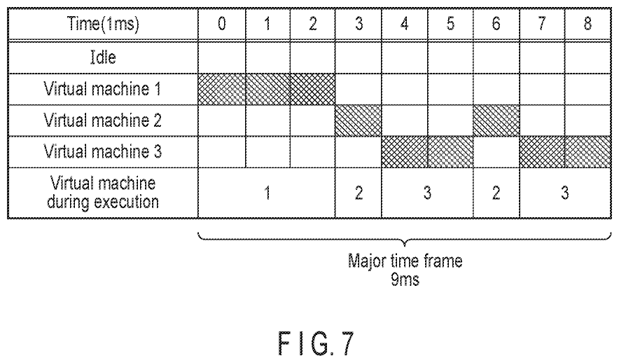

Next, operation control information that defines the operation of the information processing device 4 is described with reference to FIG. 7.

Here, a case in which a plurality of virtual machines that execute information processing by a virtual machine monitor also referred to as virtualization software or a hypervisor in the information processing device 4 perform execution, and execution of each of the plurality of virtual machines is scheduled based on scheduling information is described. Note that the scheduling information is information indicating a schedule in which a processor (for example, the processing execution unit 404 realized by the core of the CPU) included in the information processing device 4 executes processing in units of virtual machines.

FIG. 7 illustrates an example of scheduling information. There are various methods for scheduling, but here, it is assumed that the scheduling method of ARINC 653 is used.

A major time frame and a minor time frame are used in the scheduling method of ARINC 653, and the major time frame has a structure including at least one minor time frame.

In the example illustrated in FIG. 7, a major time frame having a length of 9 ms is defined, and execution of three virtual machines 1 to 3 is defined as a minor time frame. In FIG. 7, hatched portions indicate time for executing (processing of) each virtual machine.

Note that, although FIG. 7 illustrates an example in which 1 ms is allocated to each minor time frame for convenience, in the major time frame, time to be freely allocated to the minor time frame (execution time of the minor time frame) can be designated by an offset from a start timing of the major time frame. In the following description, a break of the execution time of the minor time frame (that is, the length of the minor time frame) is referred to as a time slot.

According to such scheduling information, the scheduling for executing the virtual machine 1 to 3 in each time slot (minor time frame) can be repeated with the major time frame including the time slots “0” to “8” as one cycle.

The scheduling information described above is an example of the operation control information in which the operation of the information processing device 4 is defined.

Here, in order to improve the efficiency of the processing in the entire control system 1, the information processing device 4 desirably operates with reference to the global time synchronized in the entire control system 1. Therefore, the start timing of the major time frame is designated by the global time.

Meanwhile, since the switching of the processing with reference to the global time has a large overhead as described above, the processing other than the start of the major time frame is switched by using the local time (for example, a time stamp counter which is a local time of the CPU).

That is, the virtual machine monitor adjusts the start timing of the major time frame to the global time and executes the virtual machine defined in the minor time frame after the major time frame is started with reference to the local time.

As described above, the scheduling unit 403 included in the information processing device 4 in the comparative example of the present embodiment can control the operation (execution of each virtual machine) of the information processing device 4 based on the global time, the local time, and the scheduling information (operation control information).

Note that the scheduling information is given to each of the processing execution units (processing execution units realized by the respective cores of the CPU) 404 included in the information processing device 4.

In addition, although the scheduling information is conceptually described in FIG. 7, it is assumed that the scheduling information includes start time of the major time frame designated by the global time, the length of the major time frame, the start offset of each minor time frame (offset from a start position of the major time frame), the length of a minor time frame (length of a time slot), and the correspondence relationship of the virtual machine of which execution is defined in each minor time frame. Note that, as illustrated in FIG. 7, in the minor time frame, for example, idle (state) for waiting for execution of the virtual machine may be defined.

Here, the gate control information is described as the operation control information in which the operation of the communication transfer device 3 is defined, and the scheduling information is described as the operation control information in which the operation of the information processing device 4 is defined. However, it can be said that the periodic operation and the control operation are defined in the operation control information in the present embodiment.

The periodic operation is an operation (process) for one cycle performed based on the operation control information. The periodic operation in the communication transfer device 3 is, for example, an operation of performing gate control corresponding to all entries included in the gate control information illustrated in FIG. 6 and corresponds to an operation performed at a cycle time. In addition, the periodic operation in the information processing device 4 is, for example, an operation of executing the virtual machine defined in all the minor time frames in the scheduling information illustrated in FIG. 7 and corresponds to an operation performed at the time of the length of the major time frame.

The control operation is an operation (process) performed with reference to the local time during the periodic operation. The control operation in the communication transfer device 3 is, for example, an operation of performing gate control corresponding to one entry included in the gate control information illustrated in FIG. 6 and corresponds to an operation performed during a time interval included in the entry. Furthermore, the control operation in the information processing device 4 is, for example, an operation of executing a virtual machine defined in one minor time frame in the scheduling information illustrated in FIG. 7 and corresponds to an operation performed during time allocated to the minor time frame (during a time interval of a time slot).

The operation control information includes periodic operation time and control operation time. The periodic operation time is time during which the above-described periodic operation is performed and corresponds to the cycle time included in the gate control information and the length of the major time frame included in the scheduling information. In addition, the control operation time is time allocated to the control operation described above and corresponds to a time interval included in each entry in the gate control information and a time interval of each time slot included in the scheduling information (time allocated to the minor time frame).

By the way, it is described that the communication transfer device 3 and the information processing device 4 in the comparative example of the present embodiment operate with reference to both the global time and the local time. However, there is a possibility that such a communication transfer device 3 and such an information processing device 4 cannot appropriately operate (that is, the operation fails) in a case where there is a difference in ways the global time and the local time advance.

Therefore, in the present embodiment, there is provided the control system 1 that operates without inconsistency even in a case where there is a difference in the ways the global time and the local time referred to in the control devices such as the communication transfer device 3 and the information processing device 4 advance.

Hereinafter, the communication transfer device (the first communication transfer device 3a and the second communication transfer device 3b), the information processing devices (the first information processing device 4a and the second information processing device 4b), and the orchestration device 5 included in the control system 1 according to the present embodiment are described. Note that the grand master device 2 included in the control system 1 according to the present embodiment is as described in the comparative example of the present embodiment described above, and thus a detailed description thereof is omitted here.

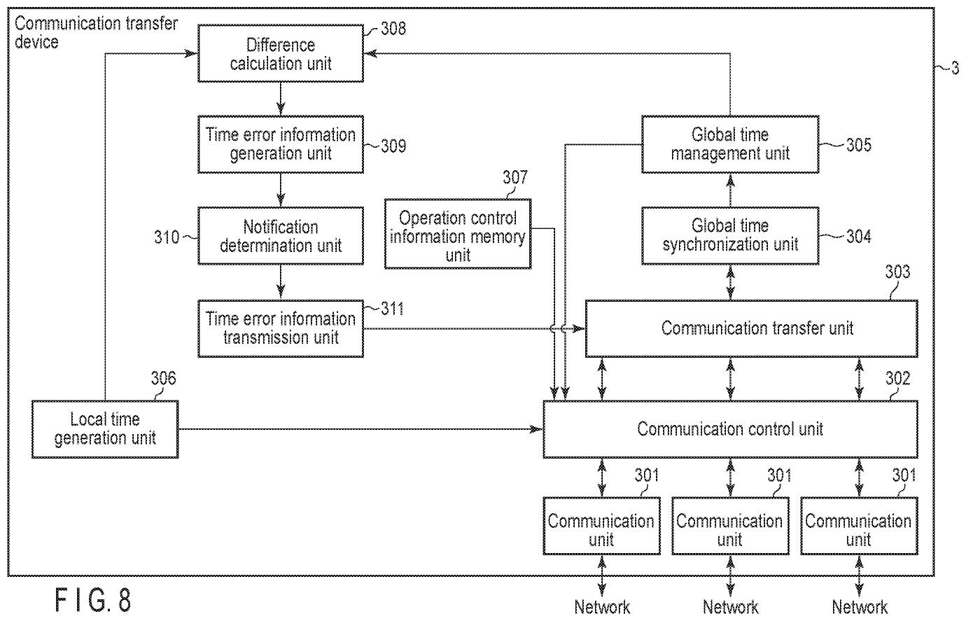

FIG. 8 illustrates an example of a functional configuration of the communication transfer device (communication control device) according to the present embodiment. In FIG. 8, the same portions as those in FIG. 3 are denoted by the same reference numerals, and the detailed description thereof is omitted. Here, portions different from those in FIG. 3 are mainly described.

As illustrated in FIG. 8, the communication transfer device 3 includes a difference calculation unit 308, a time error information generation unit 309, a notification determination unit 310, and a time error information transmission unit 311 in addition to the units 301 to 307 described in FIG. 3.

The difference calculation unit 308 calculates a difference between the global times based on the global time managed by the global time management unit 305. Furthermore, the difference calculation unit 308 calculates a difference between the local times based on the local time generated by the local time generation unit 306.

The time error information generation unit 309 generates time error information indicating a time error based on the difference between the global times and the difference between the local times calculated by the difference calculation unit 308.

The notification determination unit 310 determines whether to notify the time error information based on the time error information generated by the time error information generation unit 309. Note that the notification determination unit 310 executes processing of determining whether the time error indicated by the time error information satisfies a predetermined condition.

When the notification determination unit 310 determines to notify the time error information, the time error information transmission unit 311 transmits the time error information. The time error information transmitted by the time error information transmission unit 311 is transmitted (notified) to the orchestration device 5 via the communication transfer unit 303, the communication control unit 302, and the communication unit 301.

Note that some or all of the units 308 to 311 illustrated in FIG. 8 may be realized by a computer of the communication transfer device 3 executing a predetermined program (that is, software), may be realized by hardware, or may be realized by a combination of software and hardware.

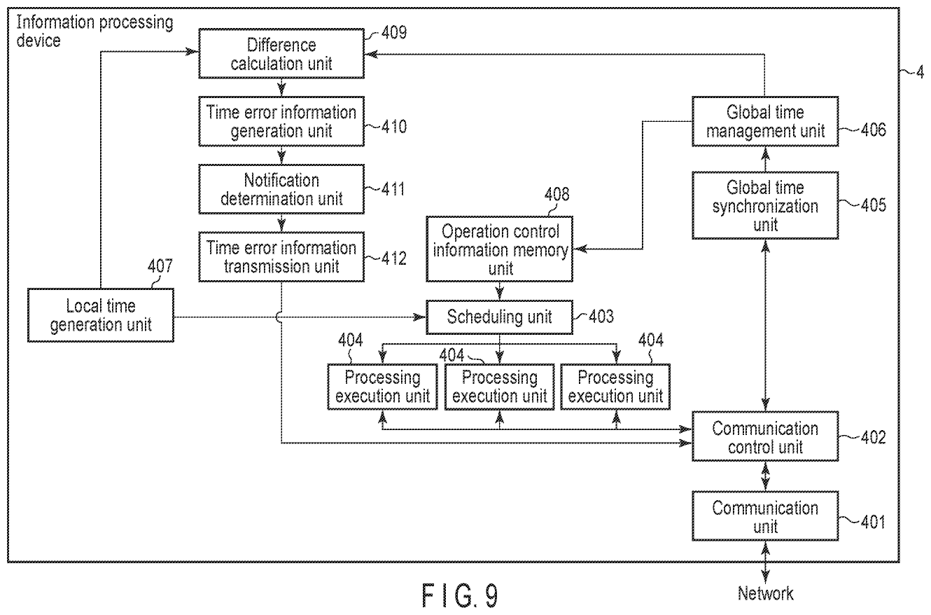

FIG. 9 illustrates an example of a functional configuration of the information processing device (calculation control device) according to the present embodiment. In FIG. 9, the same portions as those in FIG. 4 are denoted by the same reference numerals, and the detailed description thereof is omitted. Here, portions different from those in FIG. 4 are mainly described.

As illustrated in FIG. 9, the information processing device 4 includes a difference calculation unit 409, a time error information generation unit 410, a notification determination unit 411, and a time error information transmission unit 412 in addition to the units 401 to 408 described in FIG. 4.

Note that the difference calculation unit 409, the time error information generation unit 410, the notification determination unit 411, and the time error information transmission unit 412 included in the information processing device 4 are functional units similar to the difference calculation unit 308, the time error information generation unit 309, the notification determination unit 310, and the time error information transmission unit 311 included in the communication transfer device 3 described above.

That is, the difference calculation unit 409 calculates a difference between the global times based on the global time managed by the global time management unit 406. Furthermore, the difference calculation unit 409 calculates a difference between the local times based on the local time generated by the local time generation unit 407.

The time error information generation unit 410 generates time error information indicating a time error based on the difference between the global times and the difference between the local times calculated by the difference calculation unit 409.

The notification determination unit 411 determines whether to notify the time error information based on the time error information generated by the time error information generation unit 410. Note that the notification determination unit 411 executes processing of determining whether the time error indicated by the time error information satisfies a predetermined condition.

When the notification determination unit 411 determines to notify the time error information, the time error information transmission unit 412 transmits the time error information. The time error information transmitted by the time error information transmission unit 412 is transmitted (notified) to the orchestration device 5 via the communication control unit 402 and the communication unit 401.

Note that some or all of the units 409 to 412 illustrated in FIG. 9 may be realized by a computer of the information processing device 4 executing a predetermined program (that is, software), may be realized by hardware, or may be realized by a combination of software and hardware.

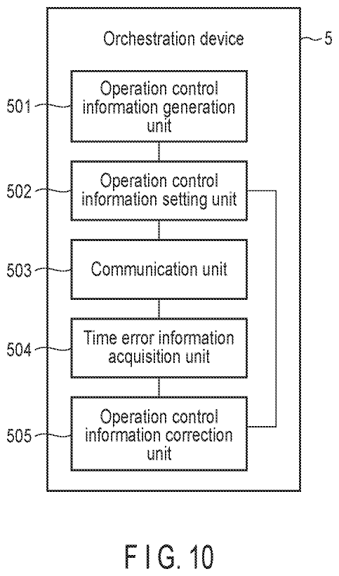

FIG. 10 illustrates an example of a functional configuration of the orchestration device 5 (operation control device) according to the present embodiment. In FIG. 10, the same portions as those in FIG. 5 are denoted by the same reference numerals, and the detailed description thereof is omitted. Here, portions different from those in FIG. 5 are mainly described.

As illustrated in FIG. 10, the orchestration device 5 includes a time error information acquisition unit 504 and an operation control information correction unit 505 in addition to the units 501 to 503 described in FIG. 5.

The time error information acquisition unit 504 acquires the time error information transmitted (notified) from the communication transfer device 3 as described above via the communication unit 503. Also, the time error information acquisition unit 504 acquires the time error information transmitted (notified) from the information processing device 4 as described above via the communication unit 503.

The operation control information correction unit 505 corrects the operation control information set for the communication transfer device 3 and the information processing device 4 based on the time error information acquired by the time error information acquisition unit 504.

Note that some or all of the units 504 and 505 illustrated in FIG. 10 may be realized by a computer of the orchestration device 5 executing a predetermined program (that is, software), may be realized by hardware, or may be realized by a combination of software and hardware.

Hereinafter, the operation of the control system 1 according to the present embodiment is described. Here, processing for notifying the time error information (hereinafter, it is referred to as time error information notification processing) and processing for correcting the operation control information (hereinafter, referred to as operation control information correction processing) are described.

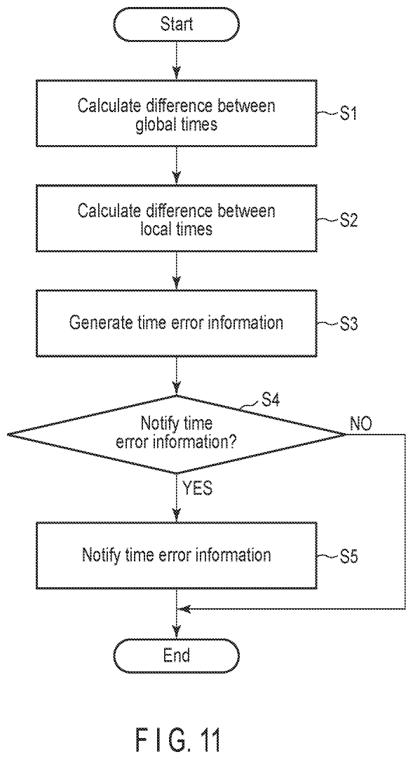

First, an example of a processing procedure of the time error information notification processing is described with reference to a flowchart of FIG. 11. Note that the time error information notification processing is executed in the communication transfer device 3 and the information processing device 4.

In the present embodiment, the time error information notification processing is executed, for example, periodically. Specifically, the time error information notification processing can be executed, for example, as timer processing. Note that the timer processing is processing executed every time a certain period of time is measured at the local time, for example, once per second. In a case where the time error information notification processing is executed in the communication transfer device 3, the time error information notification processing can be executed, for example, in a case where a counter value reaches a certain threshold in a circuit operating on a local clock. Furthermore, in a case where the time error information notification processing is executed in the information processing device 4, the time error information notification processing may be executed, for example, based on a timer function mounted on the CPU.

In addition, the time error information notification processing may be executed according to the above-described periodic operation. In this case, the time error information notification processing in the communication transfer device 3 can be executed, for example, at a start timing of gate control corresponding to the first entry (or an end timing of the gate control of the last entry) included in the gate control information. Specifically, in a case where the cycle time in the gate control information is 30 ms, the time error information notification processing can be executed each time the start timing of the gate control corresponding to the first entry included in the gate control information is detected in a cycle of 30 ms based on the global time.

Furthermore, the time error information notification processing in the information processing device 4 can be executed at the start timing of the major time frame (or the end timing of the major time frame) in the scheduling information. Specifically, when the length of the major time frame in the scheduling information is 30 ms, the time error information notification processing can be executed each time the start timing of the major time frame is detected in a cycle of 30 ms based on the global time.

Note that the timing at which the time error information notification processing is executed (processing start time), for example, may be instructed by the orchestration device 5 (may be set in the operation control information generated by the orchestration device 5). Further, the time error information notification processing may be executed, for example, according to initialization processing in the control system 1.

Hereinafter, for convenience, it is described that the time error information notification processing is executed in the communication transfer device 3. However, the time error information notification processing executed in the information processing device 4 is similar as described above.

First, the difference calculation unit 308 included in the communication transfer device 3 acquires the global time managed by the global time management unit 305 from the global time management unit 305 and calculates a difference between the global times (step S1).

Next, the difference calculation unit 308 acquires the local time generated by the local time generation unit 306 from the local time generation unit 306 and calculates a difference between the local times (step S2).

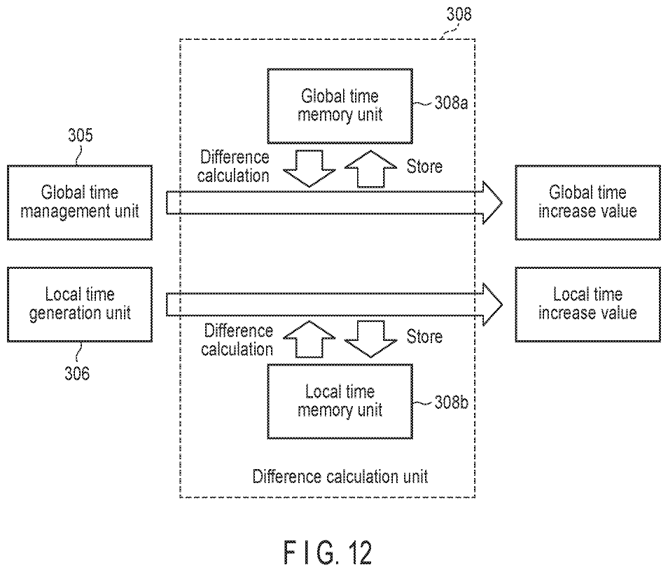

Here, the processing (that is, the operation of the difference calculation unit 308) in steps S1 and S2 described above is described with reference to FIG. 12. In the present embodiment, the global time is acquired from the global time management unit 305 every time the time error information notification processing is executed, but the difference calculation unit 308 is configured to store the past global time (for example, global time acquired when the immediately preceding time error information notification processing is executed) in a global time memory unit 308a.

Accordingly, in step S1 described above, the difference calculation unit 308 can calculate (measure) a difference (hereinafter, referred to as a global time increase value) between the present global time (current global time) acquired from the global time management unit 305 and the past global time (previous global time) stored in the global time memory unit 308a. The global time increase value corresponds to elapsed time from the previous global time to the current global time.

When the processing of step S1 is executed, the difference calculation unit 308 outputs the calculated global time increase value and also stores (overwrites) the current global time in the global time memory unit 308a in order to use the current global time as the previous global time in the next time error information notification processing.

In the same manner, in the present embodiment, the local time is acquired from the local time generation unit 306 every time the time error information notification processing is executed, but the difference calculation unit 308 is configured to store the past local time (for example, local time acquired when the immediately preceding time error information notification processing is executed) in a local time memory unit 308b.

Accordingly, in step S2 described above, the difference calculation unit 308 can calculate (measure) a difference (hereinafter, referred to as a local time increase value) between the present local time (current local time) acquired from the local time generation unit 306 and the past local time (previous local time) stored in the local time memory unit 308b. The local time increase value corresponds to elapsed time from the previous local time to the current local time.

When the processing of step S2 is executed, the difference calculation unit 308 outputs the calculated local time increase value and also stores (overwrites) the current local time in the local time memory unit 308b in order to use the current local time as the previous local time in the next time error information notification processing.

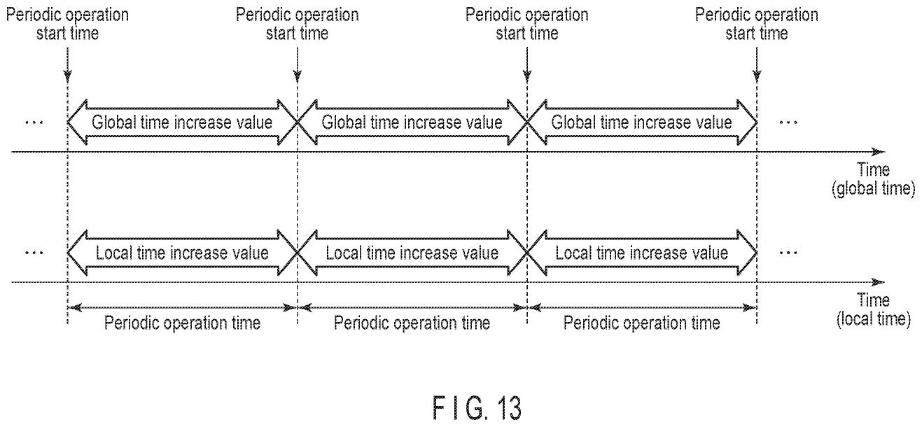

FIG. 13 conceptually illustrates global time increase value and local time increase value measured, for example, according to a periodic operation. In the present embodiment, for example, the communication transfer device 3 operates with reference to the global time and the local time (that is, the operation is performed in the time based on the global time and the time based on the local time), but the periodic operation (for example, gate control corresponding to the first entry included in the gate control information) is started based on the global time.

In the present embodiment, for example, every time the periodic operation is started (that is, for each periodic operation), the global time increase value and the local time increase value corresponding to the periodic operation time are measured.

In FIG. 13, it is assumed that the time error information notification processing is executed according to the periodic operation. However, also in a case where the time error information notification processing is executed as the timer processing executed each time a certain period of time is measured, it is possible to similarly measure the global time increase value and the local time increase value.

Note that the acquisition (reading) of the global time and the local time in steps S1 and S2 described above is preferably performed simultaneously. Therefore, it is assumed that a hardware configuration capable of simultaneously acquiring the global time and the local time is realized in the communication transfer device 3. Meanwhile, in a case where it is difficult to realize such a hardware configuration (that is, simultaneously acquire the global time and the local time), the global time and the local time are acquired so as not to continuously deviate within a possible range by the CPU processing or the like.

Referring back to FIG. 11, the time error information generation unit 309 generates the time error information based on the global time increase value and the local time increase value output from the difference calculation unit 308 (step S3). The time error information generated in step S3 has a data structure including, for example, a global time increase value and a local time increase value in association with each other as one set.

Note that the global time increase value and the local time increase value included in the time error information are in the same unit and are expressed, for example, in units of nanoseconds.

In addition, the time error information may include not only one set of the global time increase value and the local time increase value but also a plurality of sets of the global time increase values and the local time increase values (that is, the history of the global time increase values and the local time increase values).

Furthermore, the time error information may include statistical information of the global time increase value and statistical information of the local time increase value in a predetermined period (hereinafter, referred to as a measurement period) obtained by aggregating a plurality of samples of the global time increase value and the local time increase value measured each time the time error information notification processing is executed. In this case, the statistical information of the global time increase value includes, for example, at least one of a maximum value, a minimum value, an average value, and a standard deviation of the global time increase value during the measurement period. In the same manner, the statistical information of the local time increase value includes, for example, at least one of a maximum value, a minimum value, an average value, and a standard deviation of the local time increase value during the measurement period.

The time error information may include the measurement period described above. This measurement period may be represented, for example, by a frequency (or cycle) of a clock for generating a local time and a counter value. For example, in the case of 125 MHz for 100 counters, the measurement period can be represented by a frequency of 125 MHz and a counter value of 100. Note that the measurement period may be calculated from the frequency of the clock and the counter value such as 8 ns×100=800 ns.

Furthermore, for example, in a case where the communication control unit 302 included in the communication transfer device 3 uses a different clock for each communication unit 301 (that is, there are a plurality of local times in the communication transfer device 3), the time error information may be generated for each local time. Furthermore, in a case where communication control is performed by using a plurality of clocks (clock sources) in this manner, the time error information may include information of the clock source.

Although the communication transfer device 3 is described here, in a case where the processing execution unit 404 realized by each core of the CPU in the information processing device 4 operates at different local time for each core, the time error information may be generated for each core (that is, the local time).

When the processing in step S3 is executed, the notification determination unit 310 determines whether to notify the orchestration device 5 of the time error information based on the time error information generated in step S3 (step S4).

Here, the processing in step S4 is executed based on a notification condition prepared in advance (for example, a notification condition stored in advance in the notification determination unit 310). The notification condition includes, for example, that a difference between the global time increase value and the local time increase value included in the time error information is greater than or equal to a predetermined value (constant threshold value). The fact that the difference between the global time increase value and the local time increase value is greater than or equal to a predetermined value means that a predetermined error (deviation) occurs in the ways the global time and the local time advance.

The above-described notification condition is an example, and another notification condition may be applied in step S4. For example, by setting a range (upper limit value and lower limit value) in which notification is not performed for a value obtained by dividing the global time increase value by the local time increase value, a condition that the value obtained by dividing the global time increase value included in the time error information by the local time increase value does not fall within the set range may be used as the notification condition. The upper limit value and the lower limit value in the notification condition may be determined based on the statistical information of the global time increase value and the statistical information of the local time increase value described above.

Furthermore, the notification condition may be a condition related to the frequency of notification. Specifically, the notification condition may be, for example, that time error information notification processing has been executed a predetermined number of times. In this case, the time error information may be generated only when the notification condition is satisfied (that is, the time error information notification processing corresponding to the predetermined number of times is executed).

Note that, although the plurality of notification conditions have been described here, the notification condition used in step S4 may be one of the plurality of notification conditions or a combination of two or more of the plurality of notification conditions.

When it is determined that the time error information is to be notified (that is, the time error information satisfies the notification condition) (YES in step S4), the time error information generated in step S3 is notified to the orchestration device 5 (step S5). In this case, the time error information is transmitted from the time error information transmission unit 311 to the communication control unit 302. The communication control unit 302 determines a communication unit 301 corresponding to a communication port connected to the orchestration device 5 or another communication transfer device 3 connected to the orchestration device 5 and transmits the time error information via the determined communication unit 301.

Meanwhile, when it is determined that the time error information is not to be notified (that is, the time error information does not satisfy the notification condition) (NO in step S4), the processing of step S5 is not executed.

Note that, for example, in a case where a local time is generated for each of a plurality of clocks in the communication transfer device 3, it is assumed that the time error information notification processing is executed for each local time.

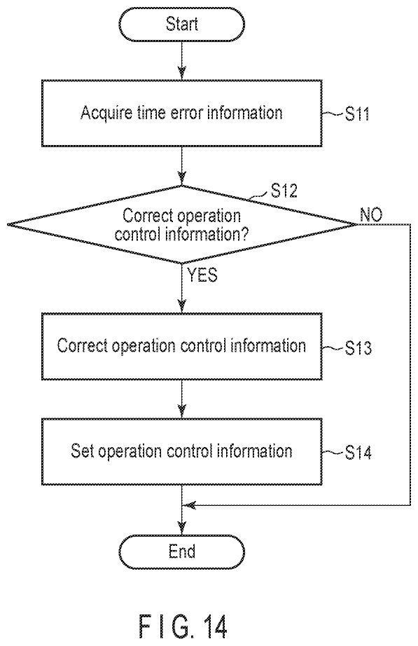

Next, an example of a processing procedure of the operation control information correction processing is described with reference to a flowchart of FIG. 14.

Note that, in FIG. 14, it is described that operation control information (for example, gate control information) in which the operation of the communication transfer device 3 is defined and operation control information (for example, scheduling information) in which the operation of the information processing device 4 is defined have already been set in the orchestration device 5.

Here, a case where the time error information is transmitted (notified) from the communication transfer device 3 or the information processing device 4 by execution of the time error information notification processing illustrated in FIG. 11 is assumed. In this case, the communication unit 503 included in the orchestration device 5 receives the time error information. The time error information acquisition unit 504 acquires the time error information received by the communication unit 503 in this manner (step S11).

When the processing of step S11 is executed, the operation control information correction unit 505 determines whether to correct (change) the operation control information that has already been set based on the time error information acquired in step S11 (step S12).

Here, the processing in step S12 is executed based on a correction condition prepared in advance (for example, a correction condition stored in advance in the operation control information correction unit 505). Note that the correction condition may be, for example, the same as the notification condition described above but may be a condition at least partially different from the notification condition. In addition, since the time error information is notified (received by the orchestration device 5) in a case where the notification condition is satisfied, in a case where the correction condition is the same as the notification condition, it is regarded that the time error information satisfies the correction condition, and the processing of step S12 may be omitted.

When it is determined that the operation control information is corrected (that is, the time error information satisfies the correction condition) (YES in step S12), the operation control information correction unit 505 corrects the operation control information (step S13). When the time error information is notified from the communication transfer device 3, the gate control information set for the communication transfer device 3 (communication control unit 302) is corrected in step S13. Meanwhile, in a case where the time error information is notified from the information processing device 4, the scheduling information set for the information processing device 4 (scheduling unit 403) is corrected in step S13.

Next, the operation control information setting unit 502 sets the operation control information corrected in step S13 (step S14).

Specifically, when the gate control information is corrected based on the time error information notified from the communication transfer device 3, the corrected gate control information is set for the communication transfer device 3 as operation control information in which the operation of the communication transfer device 3 is defined and is transmitted to the communication transfer device 3 via the communication unit 503. According to this, the gate control information (corrected gate control information) transmitted from the orchestration device 5 is stored (set) in the operation control information memory unit 307 of the communication transfer device 3, and the operation of the communication transfer device 3 is controlled based on the gate control information.

Meanwhile, in a case where the scheduling information is corrected based on the time error information notified from the information processing device 4, the corrected scheduling information is set for the information processing device 4 as operation control information in which the operation of the information processing device 4 is defined and is transmitted to the information processing device 4 via the communication unit 503. According to this, the scheduling information (corrected scheduling information) transmitted from the orchestration device 5 is stored (set) in the operation control information memory unit 408 of the information processing device 4, and the operation of the information processing device 4 is controlled based on the scheduling information.

Furthermore, as described above, in a case where the time error information for each local time is notified from the communication transfer device 3 or the information processing device 4, for example, the operation control information in which the operation to be performed with reference to the local time is defined is corrected based on the time error information notified for each local time.

When it is determined in step S12 that the operation control information is not corrected, the processing in steps S13 and S14 is not executed, and the operation control information correction processing ends.

Hereinafter, the processing of step S13 illustrated in FIG. 14 (operation control information correction processing) is described. As described above, the operation control information corrected in the present embodiment includes the gate control information and the scheduling information, but the gate control information and the scheduling information are common in that the periodic operation is started according to the global time (that is, the start time of the periodic operation is determined by the global time), and the operation after the periodic operation is started (that is, the control operation performed during the periodic operation) is performed according to the local time.

Here, in a case where the operation is controlled based on the operation control information (gate control information and scheduling information), when there is a deviation in the ways between the global time and the local time advance (for example, there is a difference of a threshold or more between the global time increase value and the local time increase value), it is necessary to correct (change) the operation control information.

Specifically, in a case where the local time advances later (slower) than the global time, the control operation is not completed to the end, and the processing transitions to the next periodic operation in the middle of the control operation.

For example, in the gate control information illustrated in FIG. 6, the gate control corresponding to entry “T00” is started based on the global time, and the gate control corresponding to entries “T01” to “T03” is performed with reference to the local time. However, in a case where the local time proceeds later than the global time, the gate control of the next entry “T00” is started based on the global time before the gate control corresponding to the entry “T03” is completed.

Here, the description has been made by using the gate control information illustrated in FIG. 6, but similarly in the scheduling information illustrated in FIG. 7, when the local time advances later than the global time, the next major time frame is started based on the global time before the execution of the virtual machine in the time slot “8” is completed.

Meanwhile, in a case where the local time advances earlier than the global time, each control operation (operation performed with reference to the local time) is completed short.

In this case, for example, in the gate control information illustrated in FIG. 6, the time interval for opening each queue originally assumed in each entry cannot be secured. In addition, for example, in the scheduling information illustrated in FIG. 7, the execution time of each virtual machine originally assumed cannot be secured.

As described above, in a case where ways the global time and the local time advance deviate from each other, the communication transfer device 3 and the information processing device 4 do not perform appropriate operations. Therefore, the operation control information is corrected based on the time error information. Hereinafter, processing of three patterns (hereinafter, referred to as first to third processing) is described as an example of processing of correcting the operation control information.

First, the first processing is described. The first processing corresponds to processing of multiplying the control operation time by a constant while keeping the periodic operation time constant. In the first processing, it is assumed that a large error does not occur at the global time.

Specifically, in the first processing, each control operation time is multiplied by a constant determined based on the global time increase value and the local time increase value measured according to the periodic operation (that is, each control operation time is multiplied by a constant). According to this, the timing of the operation performed with reference to the local time can be adjusted to the way the global time advances.

When a constant by which each control operation time is multiplied in the first processing is n, the constant n is, for example, a ratio between the global time increase value and the local time increase value and is calculated by Expression (1) below.

$$n = Local time increase value / Global time increase value \qquad Expression ( 1 )$$

For example, in a case where the global time increase value is 10 microseconds, and the local time increase value is 10.08 microseconds, the constant n is 10.08/10=1.008.

By multiplying each control operation time during the periodic operation by the constant n calculated in this manner, the operation control information can be corrected so that the start and the end of the operation performed with reference to the local time are adjusted in association with the global time.

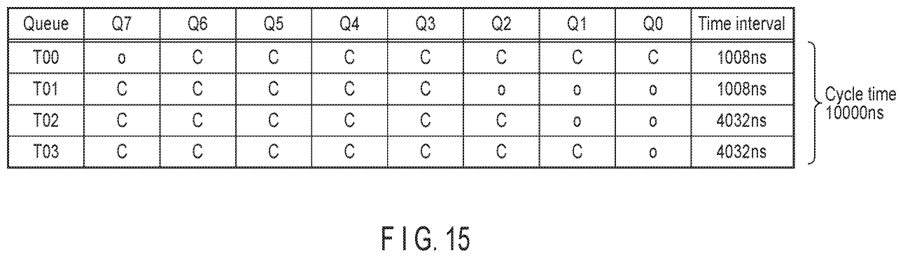

Here, FIG. 15 illustrates an example of gate control information corrected by executing first processing. FIG. 15 illustrates the gate control information in which the start and end timings of the gate control corresponding to each entry are corrected to match the way the global time advances by multiplying the time interval included in each entry in the gate control information illustrated in FIG. 6 by 1.008 as the constant n.

That is, the example illustrated in FIG. 15 illustrates that the time interval included in the entry “T00” is corrected from 1000 ns to 1008 ns, the time interval included in the entry “T01” is corrected from 1000 ns to 1008 ns, the time interval included in the entry “T02” is corrected from 4000 ns to 4032 ns, and the time interval included in the entry “T03” is corrected from 4000 ns to 4032 ns. In the first processing, the cycle time counted at the global time is not corrected.

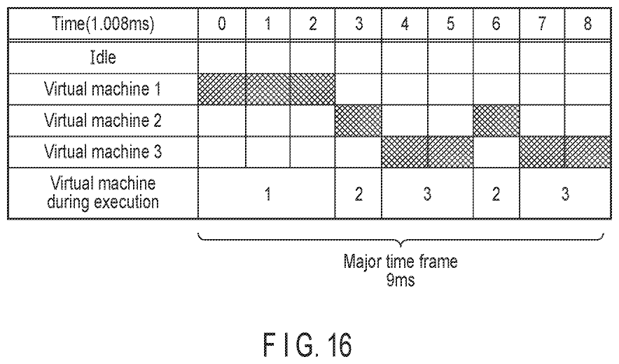

Here, the case where the gate control information is corrected is described. However, in a case where the scheduling information is corrected, the time interval of each time slot (the time allocated to each minor time frame) is corrected from 1 ms to 1.008 ms as illustrated in FIG. 16.

In FIGS. 15 and 16, it is assumed that the local time advances faster than the global time, but the operation control information (control operation time) can be similarly corrected even in a case where the local time advances slower than the global time.

When the first processing is executed, the control operation time (the start and end timings of the operation performed with reference to the local time) is corrected, but the control operation time may be further corrected in accordance with the timing at which the circuit or the like operates. Specifically, for example, in a circuit operating at 125 MHz, the operation is performed in units of 8 ns. Therefore, when the control operation time (for example, the time interval included in each entry in the gate control information and the time interval of the time slot in the scheduling information) corrected as described above is not a multiple of 8 ns, the control operation time may be rounded to a value that is a multiple of 8 ns.

In addition, the above-described constant n may be a minimum value or a maximum value of a ratio calculated based on a plurality of samples (a global time increase value and a local time increase value). The minimum value of the ratio may be used as the constant n when the local time advances faster than the global time, and the maximum value of the ratio may be used as the constant n when the local time advances slower than the global time.

Next, the second processing is described. The second processing corresponds to processing of changing the periodic operation time. In the second processing, it is assumed that an error occurs in the global time and the local time. That is, according to the second processing, for example, by lengthening the periodic operation time, it is possible to deal with a case where either the global time or the local time is deviated.

Specifically, in the second processing, the length of time for extending the periodic operation time is set as time t2, and the time t2 is calculated by Expression (2) below.

$$t 2 \geq abs ( Global time increase value - Local time increase value ) \qquad Expression ( 2 )$$

Note that abs in Expression (2) is a function that returns an absolute value. That is, the time t2 corresponds to an absolute value of a difference between the global time increase value and the local time increase value measured according to the periodic operation. The time t2 may be a maximum value or the like of an absolute value of a difference between a global time increase value and a local time increase value calculated from a plurality of samples (a global time increase value and a local time increase value).

In the second processing, in a case where the time t2 is calculated by Expression (2), the control operation of which control operation time is t2×2 is added to the end of the periodic operation, and the time t2 is added to the periodic operation time.

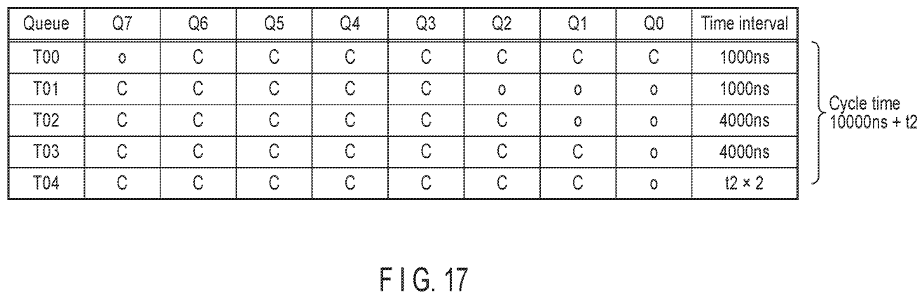

Here, FIG. 17 illustrates an example of gate control information corrected by executing second processing. According to the gate control information illustrated in FIG. 17, the entry “T04” in which only the queue “Q0” is open, and the time interval is t2×2 is added to the end of the plurality of entries (that is, periodic operations) included in the gate control information illustrated in FIG. 6. In the gate control information illustrated in FIG. 17, the cycle time is corrected from 10000 ns to 10000 ns+t2.

According to the gate control information corrected by the execution of such second processing, by adding the time t2 to the cycle time, it is possible to suppress the start of the next periodic operation before the time interval included in the last entry (entry “T03” in the case of the gate control information illustrated in FIG. 6) elapses (before the gate control corresponding to the entry is completed), for example, even in a case where the local time advances slower than the global time.

In addition, in a case where the local time advances faster than the global time, for example, since the next periodic operation (gate control corresponding to the entry “T00”) is not started even at the end timing of the gate control corresponding to the last entry, the gate control corresponding to the last entry (gate control corresponding to the entry “T03” in the case of the gate control information illustrated in FIG. 6) is continuously executed, but according to the gate control information corrected by executing the second processing, the entry “T04” including 2×2t as the time interval is added to the end of the periodic operation, so that it is possible to avoid that only specific gate control (for example, gate control corresponding to entry “T03”) is executed unreasonably long as compared with other gate control. Note that the gate control (that is, opening or closing of each queue) corresponding to the entry added to the end of the periodic operation may be appropriately set, but in the example illustrated in FIG. 17, the gate control for opening the queue “Q0” of the best effort is set.

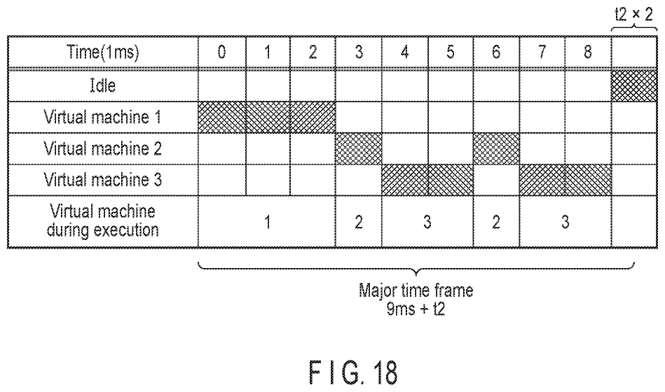

Note that FIG. 18 illustrates an example of scheduling information corrected by executing second processing. According to the scheduling information illustrated in FIG. 18, idle (state) is defined at the end of a plurality of time slots (That is, periodic operation) in the scheduling information illustrated in FIG. 7, and a time slot having a time interval of t2×2 is added. Further, in the scheduling information illustrated in FIG. 18, the length of the major time frame is corrected from 9 ms to 9 ms+t2.

According to the scheduling information corrected by the execution of the second processing, by adding t2 to the length of the major time frame, even when the local time advances slower than the global time, it is possible to suppress the start of the next periodic operation before the last execution of the virtual machine (the execution of the virtual machine 3 in the case of the scheduling information illustrated in FIG. 7) is completed.

In addition, in a case where the local time advances faster than the global time, for example, since the next periodic operation (major time frame) is not started even at the end timing of the execution of the virtual machine in the last time slot, the execution of the virtual machine in the last time slot (the execution of the virtual machine 3 in the time slot “8” of the scheduling information illustrated in FIG. 7) is continuously executed. However, according to the scheduling information corrected by executing the second processing, the time slot having the time interval t2×2 is added to the end of the periodic operation, so that it is possible to avoid that only a specific virtual machine (for example, the virtual machine 3) is executed unreasonably long compared to other virtual machines.

It is described that, in the second processing, the control operation in which the control operation time is t2×2 is added in consideration of the deviation in the ways the global time and the local time advance. However, the control operation time may be at least time t2 or more.

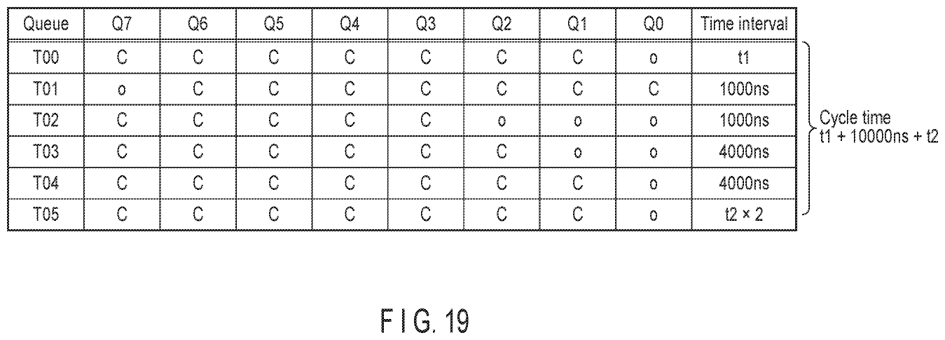

Meanwhile, in the case of the gate control information, an entry (gate control) including a time interval t1 may be further added to the beginning of the periodic operation as illustrated in FIG. 19. The time interval t1 is calculated by Expression (3) below.

$$t 1 \geq 8 \times ( F + M ) / L \qquad Expression ( 3 )$$

F in Expression (3) indicates the maximum size (the number of bytes) of the frame length, M indicates the number of bytes of the media-dependent overhead, and L indicates the link speed (bit/s). Note that the media-dependent overhead is an overhead depending on a medium that performs communication, and in the case of Ethernet, an inter frame gap (IFG), a preamble (Preamble), a start of frame delimiter (SFD), and the like are included. The number of bytes of the frame check sequence (FCS) may be added to M for convenience.

That is, the time interval t1 in Expression (1) means a value equal to or more than the time during which one frame (maximum size) can pass through the gate.

Here, for example, in a case where the operation (the periodic operation and the control operation) of the communication transfer device 3 is controlled based on the gate control information illustrated in FIG. 17, it is assumed that the local time advances slower than the global time. In this case, since the cycle time is 10000 ns+t2, and the entry “T04” is added to the end of the periodic operation in the gate control information illustrated in FIG. 17, the gate control corresponding to the entry “T03” which is originally the end can be completed according to the gate control information.

However, in this case, the gate control corresponding to the entry “T04” next to the entry “T03” is started, but it is highly likely that the gate control is interrupted by starting of the next periodic operation. In a case where there is a frame being transmitted in the gate control corresponding to the entry “T04” interrupted in this way, it is necessary to complete the transmission of the frame even when the next periodic operation is started, which affects the transmission operation of the frame of the queue Q7 with high priority in the entry arranged at the beginning of the periodic operation (the entry “T00” in the case of the gate control information illustrated in FIG. 17).

Meanwhile, according to the gate control information to which the entry including the time interval t1 is added at the beginning as illustrated in FIG. 19, even when there is a frame being transmitted in the gate control corresponding to the entry at the end of the interrupted periodic operation in the case where the local time advances slower than the global time as described above, since the transmission of the frame can be completed in the time interval included in the added entry (entry “T00” in the gate control information illustrated in FIG. 19), there is no influence on the gate control corresponding to the queue Q7 with high priority (entry “T01” in the gate control information illustrated in FIG. 19).

Note that, since the periodic operation time (process execution cycle) is changed in the second processing described above, for example, in a case where a plurality of devices such as the communication transfer device 3 and the information processing device 4 operate at the same cycle, only the operation control information for the device alone cannot be changed, and the operation control information needs to be changed in the entire control system 1.

In this case, for example, the maximum value of the time t2 calculated based on the time error information notified from each of the communication transfer device 3 and the information processing device 4 may be adopted, and the operation control information (the gate control information and the scheduling information) set for the communication transfer device 3 and the information processing device 4 may be corrected (changed) using the maximum value.

Next, the third processing is described. In the second processing described above, it is described that the operation control information is corrected by changing the periodic operation time (adding the time t2 to the periodic operation time). However, in a case where the constraint condition (maximum delay or the like designated by the application, the user, or the like) in each control operation (operation performed with reference to the local time) cannot be satisfied by the operation control information corrected in this manner, it is necessary to regenerate (reconstruct) the operation control information instead of correcting the operation control information. That is, the third processing corresponds to processing of newly generating operation control information.

First, in the third processing, in order to estimate the time required for each control operation, the constant n described in the first processing is calculated, and a constant m is further calculated by Expression (4) below.

$$m = max ( n , 1 / n ) \qquad Expression ( 4 )$$

max in Expression (4) above is a function that returns the maximum value of the given argument. That is, according to Expression (4), the constant m is a larger value of n and 1/n. That is, for example, when the local time advances faster than the global time, the constant m is n. Meanwhile, for example, when the local time advances slower than the global time, the constant m is 1/n.

Note that the constant m may be calculated by using a minimum value or a maximum value of a ratio calculated based on a plurality of samples (a global time increase value and a local time increase value), as the constant m.

Next, in the third processing, new operation control information is generated by using a value (execution time required for each processing) obtained by multiplying each control operation time (control operation time included in the operation control information before correction) in the periodic operation by the constant m.

In this case, as a simple example, the operation control information including the periodic operation time (the cycle time or the length of the major time frame) calculated by multiplying the control operation time (for example, a time interval included in each entry in the gate control information or a time interval of a time slot in the scheduling information) by the constant m may be generated. However, in the third processing, the operation control information that satisfies the above-described predetermined constraint condition is generated.

Since it is likely that the periodic operation time (process execution cycle) is changed in the third processing, the operation control information is regenerated (changed) in the entire control system 1 similarly to the second processing described above.

In this case, for example, the maximum value of the constant m calculated based on the time error information notified from each of the communication transfer device 3 and the information processing device 4 may be adopted, and the operation control information (the gate control information and the scheduling information) set for the communication transfer device 3 and the information processing device 4 may be generated using the maximum value.

Furthermore, when the operation control information is regenerated as described in the third processing, the operation control information correction unit 505 may instruct the operation control information generation unit 501 to regenerate the operation control information.

As described above, the first control device (the communication transfer device 3 or the information processing device 4) in the present embodiment manages, for example, the global time provided by the grand master device 2, generates the local time, controls the operation of the first control device based on the global time, the local time, and the operation control information defining the operation of the first control device, and generates the time error information indicating the time error based on the global time and the local time. In addition, the second control device (orchestration device 5) according to the present embodiment acquires the time error information generated by the first control device and corrects the operation control information based on the acquired time error information.

In the present embodiment, with such a configuration, by correcting the operation control information so as to allow a time error in the first control device of which the operation is controlled with reference to both the global time and the local time, it is possible to realize an appropriate operation without inconsistency in the first control device even when there is an error in the ways the global time and the local time advance.

Furthermore, in the present embodiment, for example, even in a situation where a time error dynamically occurs, it is possible to detect the error and correct the operation control information.

Note that, for example, in a case where the first control device generates the local time for each of the plurality of clocks (that is, the operation of the first control device is controlled with reference to the plurality of local times), it is assumed that the time error information is generated for each local time. According to such a configuration, it is possible to correct the operation control information in which the operation performed with reference to the local time is defined according to the deviation of each of the plurality of local times.

Furthermore, in the present embodiment, the operation control information includes an operation time indicating a length of time during which the first control device operates, and the operation time is changed based on the time error information described above. Note that the operation time thus changed includes, for example, at least one of time of an operation for one cycle performed with reference to the global time (periodic operation time) and time of an operation performed with reference to the local time during the periodic operation time (control operation time). In other words, the operation time in the present embodiment intends a superordinate concept of the periodic operation time such as the cycle time and the length of the major time frame, the time interval of each entry of the gate control information, and the control operation time such as the time allocated to the minor time frame. Note that the first processing described in the present embodiment corresponds to processing of changing (correcting) the control operation time, and the second processing corresponds to processing of changing (correcting) the periodic operation time. The third processing corresponds to processing of changing (correcting) at least one or both of the periodic operation time and the control operation time.

Furthermore, in the present embodiment, it is described that the operation control information in which the operation of the communication transfer device 3 is defined is the gate control information in which opening and closing of the gate corresponding to each of the plurality of queues is set, and the operation control information in which the operation of the information processing device 4 is defined is the scheduling information indicating the schedule in which each core (processor) of the CPU included in the information processing device 4 executes processing in units of virtual machines. However, the gate control information and the scheduling information are an example of the operation control information, and the operation control information may be information used to control the operation of the first control device (the communication transfer device 3, the information processing device 4, and the like).

Specifically, in the present embodiment, the schedule information indicating the schedule for executing processing in units of virtual machines (OSs operating on the virtual machines) is described as an example of the operation control information. However, the operation control information may be information indicating a schedule for executing processing in units of tasks, processes, or threads by a processor included in the information processing device 4.

Further, in the present embodiment, when it is determined that the time error (the global time increase value and the local time increase value) indicated by the time error information satisfies the notification condition, the time error information is transmitted (notified) from the first control device to the second control device. In the present embodiment, with such a configuration, since the time error information is transmitted only when necessary, the amount of communication between the first control device and the second control device can be reduced.

In the present embodiment, the operation control information generated in the second control device is transmitted from the second control device to the first control device. However, a notification condition for determining whether to notify the time error information may be designated (set) in the second control device, and the operation control information including the notification condition may be transmitted from the second control device to the first control device. According to such a configuration, notification of the time error information can be controlled on the second control device (orchestration device 5) side. Furthermore, the operation control information transmitted from the second control device may further include, for example, a condition related to processing of calculating a time error indicated by the time error information (that is, a method of measuring the global time increase value and the local time increase value, and the like).

Further, in the present embodiment, it is described that the operation control information is corrected (changed) based on the time error information notified from the first control device. However, the second control device according to the present embodiment may be configured to output identification information for identifying the first control device that has generated the time error information satisfying a condition similar to the notification condition described above. The identification information output in this manner may be transmitted to an external device or may be displayed on a display or the like connected, for example, to the second control device.

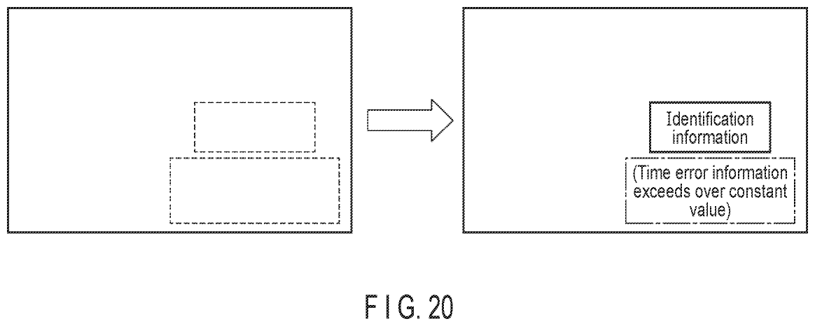

Here, FIG. 20 illustrates an example of a screen on which the above-described identification information is displayed. In the screen illustrated in FIG. 20, identification information is displayed at a predetermined position on the screen. By referring to such a screen illustrated in FIG. 20, the manager of the control system 1 can know that an error has occurred in the ways the global time and the local time advance in the first control device identified by the identification information. As in the example illustrated in FIG. 20, the reason why the identification information is displayed (“time error information exceeds over constant value” illustrated in FIG. 20 and the like) may be further displayed.

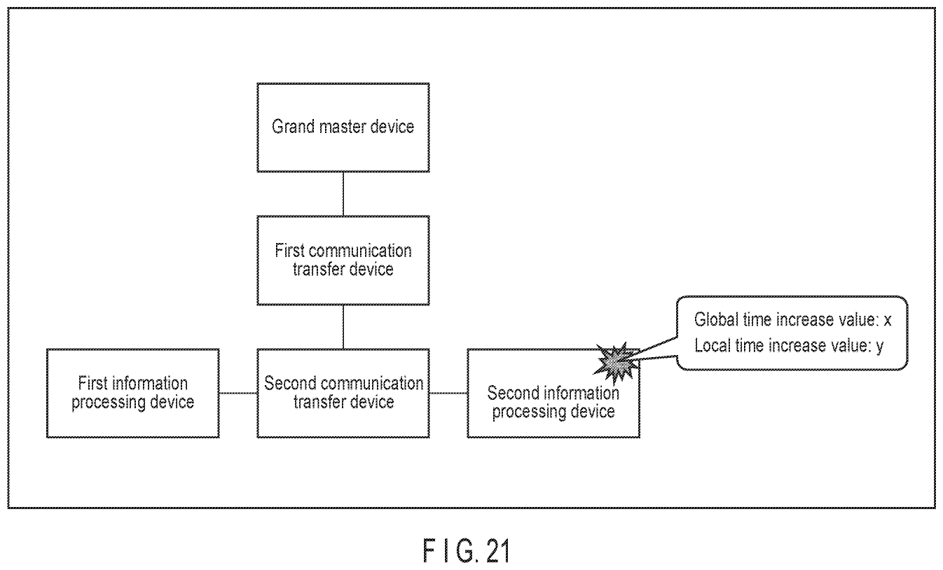

In addition, for example, a configuration in which a screen as illustrated in FIG. 21 is generated based on the identification information output from the second control device, and the screen is displayed may be applied. On the screen illustrated in FIG. 21, for example, (the network configuration of) the control system 1 including the grand master device 2, the first communication transfer device 3a, the second communication transfer device 3b, the first information processing device 4a, and the second information processing device 4b is displayed, and the fact that the time error information satisfying the notification condition (for example, a difference between the global time increase value and the local time increase value is greater than or equal to a predetermined value) is generated in the second information processing device 4b is displayed.

Note that, on the screen illustrated in FIG. 21, the global time increase value and the local time increase value included in the time error information generated by the second information processing device 4b are displayed. However, for example, other information such as a ratio between the global time increase value and the local time increase value and statistical information of the global time increase value and the local time increase value may be further displayed.

By referring to the screen illustrated in FIG. 21 described above, the manager of the control system 1 can easily know that an error occurs in the ways the global time and the local time advance in the second information processing device 4b and can examine a response to the error.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control system comprising:
first and second control devices communicably connected via a network,
wherein the first control device includes:
a management unit that manages global time;
a first generation unit that generates local time;
a control unit that controls an operation of the first control device based on the global time, the local time, and operation control information defining the operation of the first control device; and
a second generation unit that generates time error information indicating a time error based on the global time and the local time, and
the second control device includes:
an acquisition unit that acquires the generated time error information from the first control device; and
a correction unit that corrects the operation control information based on the acquired time error information.

2. The control system according to claim 1,
wherein the first generation unit generates the local time for each clock included in the first control device, and
the second generation unit generates the time error information for each local time.

3. The control system according to claim 1,
wherein the operation control information includes operation time indicating a length of time during which the first control device operates, and
the correction unit changes the operation time included in the operation control information based on the generated time error information.

4. The control system according to claim 3, wherein the changed operation time includes at least one of time of an operation for one cycle performed with reference to the global time and time of an operation performed with reference to the local time during the time of the operation for one cycle.

5. The control system according to claim 4, wherein the operation control information includes gate control information in which opening and closing of a gate corresponding to each of a plurality of queues are set.

6. The control system according to claim 4, wherein the operation control information includes scheduling information indicating a schedule in which a processor included in the first control device executes processing in a unit of a virtual machine.

7. The control system according to claim 4, wherein the operation control information includes scheduling information indicating a schedule in which a processor included in the first control device executes processing in a unit of a task, a process, or a thread.

8. The control system according to claim 1,
wherein the first control device further includes a determination unit that determines whether a time error indicated by the time error information satisfies a predetermined condition, and
the time error information is transmitted from the first control device to the second control device when it is determined that the time error satisfies the condition.

9. A control system comprising:
first and second control devices communicably connected via a network,
wherein the first control device includes:
a management unit that manages global time;
a first generation unit that generates local time;
a control unit that controls an operation of the first control device based on the global time, the local time, and operation control information defining the operation of the first control device; and
a second generation unit that generates time error information indicating a time error based on the global time and the local time, and
the second control device includes:
an acquisition unit that acquires the generated time error information from the first control device; and
an output unit that outputs identification information for identifying the first control device in a case where a time error indicated by the acquired time error information satisfies a predetermined condition.

10. A control device communicably connected to another control device via a network, the control device comprising:
a management unit that manages global time;
a first generation unit that generates local time;
a control unit that controls an operation of the control device based on the global time, the local time, and operation control information defining an operation of the control device; and
a second generation unit that generates time error information indicating a time error based on the global time and the local time,
wherein the operation control information is corrected based on the time error information in the other control device.
